(19) United States
(12) Patent Application Publication
(10) Pub. No.: US 2024/0089082 A1
(43) Pub. Date: Mar. 14, 2024

(54) PRIVACY PRESERVING DIGITAL PERSONAL ASSISTANT

(71) Applicant: Intel Corporation, Santa Clara, CA (US)

(72) Inventors: Jeremy Bottleson, North Plains, OR (US); Ernesto Zamora Ramos, Folsom, CA (US); Kylan Race, Austin, TX (US); Fillipe Dias Moreira de Souza, Folsom, CA (US); Hubert de Lassus, Folsom, CA (US); Jingyi Jin, San Jose, CA (US)

(73) Assignee: Intel Corporation, Santa Clara, CA (US)

(21) Appl. No.: 17/931,007

(22) Filed: Sep. 9, 2022

(51) Int. Cl. H04L 9/00; G10L 15/26; H04L 9/08

(52) U.S. Cl. CPC H04L 9/008; G10L 15/26; H04L 9/0825

(57) ABSTRACT

A method comprises receiving, from an input device, an input speech signal, encoding the input speech signal to generate a first homomorphically encrypted string, sending the homomorphically encrypted string to a remote device via communication link, receiving, from the remote device, a reply comprising a second homomorphically encrypted string, decoding the second homomorphically encrypted string into an output speech signal, and outputting the output speech signal on an audio output device.

### BACKGROUND

Subject matter described herein relates generally to the field of computer security and more particularly to technologies to implement a privacy preserving digital personal assistant.

Existing digital personal assistant technologies force users to surrender the content of their voice commands to their digital personal assistance provider, and most actions of the available digital personal assistants are performed in the cloud. This presents a large privacy and security concern that will only grow overtime with increased adoption. Accordingly, techniques to implement a privacy preserving digital personal assistant may find utility.

### BRIEF DESCRIPTION OF THE DRAWINGS

The detailed description is described with reference to the accompanying figures.

FIG. 1 is a schematic, block diagram illustration of components of apparatus to implement a privacy preserving digital personal assistant in accordance with some examples.

FIG. 2 is a flowchart illustrating operations in a method to implement a privacy preserving digital personal assistant in accordance with some examples.

FIG. 3 is a schematic, block diagram illustration of components of apparatus to implement a privacy preserving digital personal assistant in accordance with some examples

FIG. 4 is a flowchart illustrating operations in a method to implement a privacy preserving digital personal assistant in accordance with some examples.

FIG. 5 is a schematic illustration of a computing architecture which may be adapted to implement a privacy preserving digital personal assistant in accordance with some examples.

### DETAILED DESCRIPTION

Described herein are exemplary systems and methods to a privacy preserving digital assistant. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the examples.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

As described briefly above, existing digital personal assistant technologies force users to surrender the content of their voice commands to their digital personal assistance provider, and most actions of the available digital personal assistants are performed in the cloud. Many existing personal assistants send the raw speech signal to the Cloud server for processing and information retrieval search. In this case, the voiceprint of the user is only protected in transit via traditional encryption plus the secure socket layer and/or transport layer security (SSL/TLS) protocol. Once the raw speech signal arrives at the service provider in the cloud, it is decrypted for processing; thus, the user identify can be revealed and their privacy may be compromised. In addition to the latency of sending raw speech signal over Internet to the cloud server, the speech processing and speech-based information retrieval pipeline can be intricate and computationally intensive for their modern design rely on deep neural networks.

To address these and other issues, described herein are systems and methods to implement a privacy preserving digital personal assistant. In accordance with some examples, subject matter described herein provides a privacy-preserving voice smart assistant that is computationally efficient when protecting the user's private data using, for example, homomorphic encryption (HE). Homomorphic encryption allows computations to be performed on data that is encrypted without revealing input and output information to the entity performing the computations (e.g., compute service providers). By way of overview, in some examples a personal assistant service is provided in which voice commands from a user are encrypted locally using homomorphic encryption. This encrypted input is sent to a remote device (e.g., a compute service provider) where the data may be used in a homomorphic encryption variant of algorithms (e.g., speech to text, Natural Language Processing, etc.) used to detect the sentiment and/or command the personal assistant (PA) is to process. Once the result is computed the requesting user (and no one else) will be able to decrypt the results of the command, obtaining an answer and maintaining the privacy of their query.

Two basic processing components are described herein. The first is an edge device that resides on the premise of the user and that they interact with by voice. The second is a remote compute device (e.g., one or more servers) that may reside in the cloud and are configured to answer remote requests sent by the voice-interactive edge device. The edge device can be seen as the voice smart assistant. It interacts with the cloud server to retrieve answers for the questions and demands of the user that interacts with it. While the speech signal of the user's voice is collected on premise, the voiceprint of the user is protected and kept private.

In some examples described herein a user's voiceprint is never sent to the cloud. Instead, speech processing is performed on the user's edge device, thus protecting the privacy of the user. In some examples speech may be performed in cleartext (i.e., with unencrypted data) and may comprise extracting one or more keywords from an input speech signal that can be used to perform keyword matching in the cloud to query a database containing a deterministic set of answers in text. In addition to anonymization of the speech with text, the extracted keywords will be encrypted with a homomorphic encryption scheme to protect the semantics of the (speech) query in the cloud by performing the search homomorphically in the encrypted domain.

Encrypted text can be significantly more economic in size than its equivalent encrypted speech signal (a speech query can be summarized with set of keywords), thereby reducing communication latency overhead from the edge to the cloud. Similarly, processing time can also be reduced since the methods to perform keyword matching in query databases are simpler and less computationally expensive than speech recognition neural networks, especially when the data is in the form of a ciphertext (i.e., encrypted data) where neural networks are extremely unfriendly to levelled and fully homomorphic encryption. The database in the cloud may comprise a predefined set of matchable (or partially matchable) strings. The use of a homomorphic encryption scheme to encrypt the keywords is paramount to perform the processing without the need to decrypt the query data first; thus always keeping the semantics of the speech confidential. Several string matching algorithms exist which have a computational complexity that is lower than neural networks, making it more computationally suitable for processing in the encrypted domain.

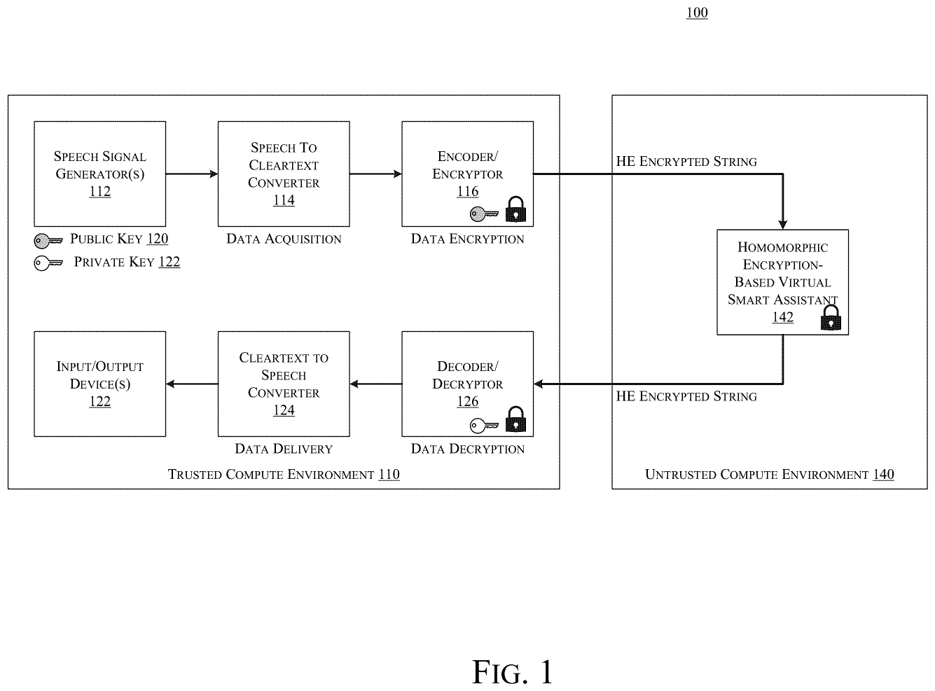

In some examples it may be desirable to protect the speech-to-text model of the smart assistant's service provider that resides on the device. For example, speech to text processing may be performed in an SGX enclave of the device thereby introducing a security layer that prevents direct access to the model by a user. Further structural and methodological details are relating to implementing a privacy preserving digital personal assistant are described below with reference to FIG. 1 through FIG. 5, below

FIG. 1 is a schematic, block diagram illustration of components in an environment 100 to implement a privacy preserving digital personal assistant in accordance with some examples. Referring to FIG. 1, in some examples, environment 100 comprises a trusted compute environment 100 and an untrusted compute environment 140.

Trusted compute environment 100 may comprise all or part of a personal compute device such as, e.g., a mobile phone, handheld device, laptop computer, tablet computer, personal computer or the like. In some examples the device(s) in the trusted compute environment 100 may comprise one or more speech generator(s) 112, a speech to cleartext converter circuit 114, an encoder/encryptor circuit 116, one or more input/output devices 122, a cleartext to speech converter circuit 124, and a decoder/decryptor circuit 126. Untrusted compute environment 140 comprises a homomorphic encryption-based virtual smart assistant 142.

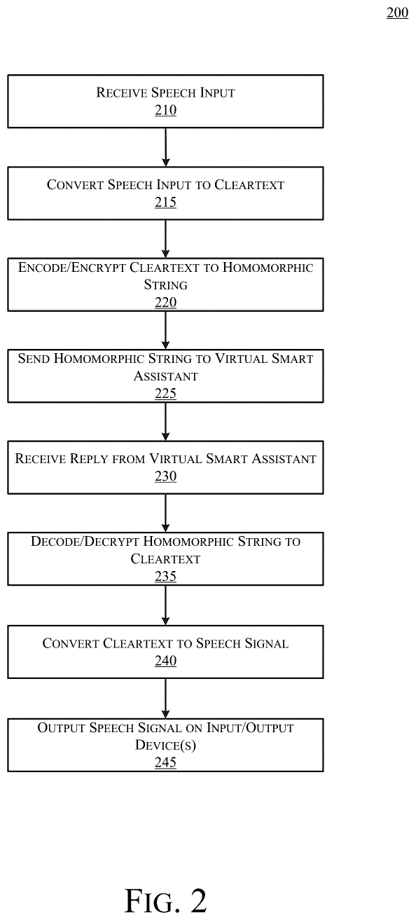

FIG. 2 is a flowchart illustrating operations in a method to implement a privacy preserving digital personal assistant in accordance with some examples. Referring to FIG. 2, in operation, a user of the trusted compute environment 100 may initiate a query to a digital personal assistant, e.g., by asking a question to the digital personal assistant. At operation 210 the speech from a user is received and is input to a speech signal generator 112 (e.g., a microphone) which, at operation 215, converts the speech input to a cleartext (i.e., unencrypted) text string. The unencrypted text string is input to the encoder/encryptor circuit 116 which, at operation 220 encodes and/or encrypts the cleartext string to an encrypted homomorphic ciphertext using a public encryption key 120 associated with the trusted compute environment 110. At operation 225 the homomorphic string is sent to the homomorphic encryption-based virtual smart assistant 142.

The homomorphic encryption-based virtual smart assistant 142 receives the homomorphically encrypted string as a ciphertext to be homomorphically evaluated to deliver the requested services without revealing input and output data, thereby preserving the privacy of the end user. In some examples the ciphertext is used to perform oblivious query on a encrypted database. This operation may comprise simple string matching algorithms that are less computationally intensive than speech processing using deep neural networks. homomorphic encryption-based virtual smart assistant 142 replies with a result in the form of a homomorphically encrypted string (i.e., ciphertext), which can only be decrypted with the private key 122.

At operation 230 the reply from the homomorphic encryption-based virtual smart assistant 142 is received in the trusted compute environment 100. At operation 235 the reply is input to the decoder/decryptor circuit 126, which decrypts the response using the private key 122 to generate a cleartext string. The cleartext string is input to the cleartext to speech converter circuit 124 which, at operation 240, converts the cleartext string to a speech signal. The speech signal is input to one or more input/output devices (e.g., a speaker) which, at operation 245, outputs the speech signal.

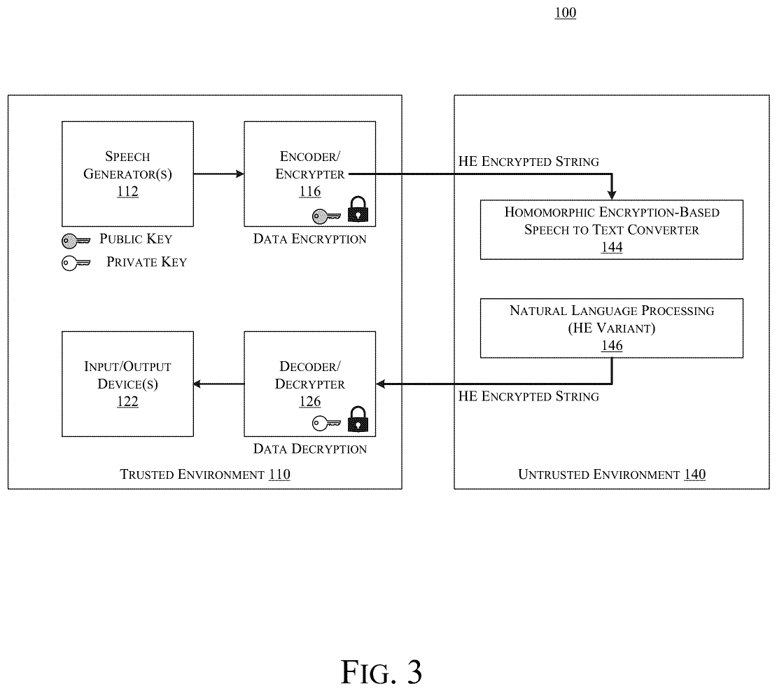

In some examples the input speech signal from a user may be converted directly into a homomorphic ciphertext and speech-to-text conversion may be performed on the homomorphic ciphertext in the cloud. FIG. 3 is a schematic, block diagram illustration of components of apparatus to implement a privacy preserving digital personal assistant in accordance with some examples. Referring to FIG. 3, in some examples, environment 100 comprises a trusted compute environment 100 and an untrusted compute environment 140.

Trusted compute environment 100 may comprise all or part of a personal compute device such as, e.g., a mobile phone, handheld device, laptop computer, tablet computer, personal computer or the like. In some examples the device(s) in the trusted compute environment 100 may comprise one or more speech generator(s) 112, an encoder/encryptor circuit 116, one or more input/output devices 122, and a decoder/decryptor circuit 126. Untrusted compute environment 140 comprises a homomorphic encryption-based speech to text converter 144 and a natural language processing module that performs on homomorphically encrypted strings.

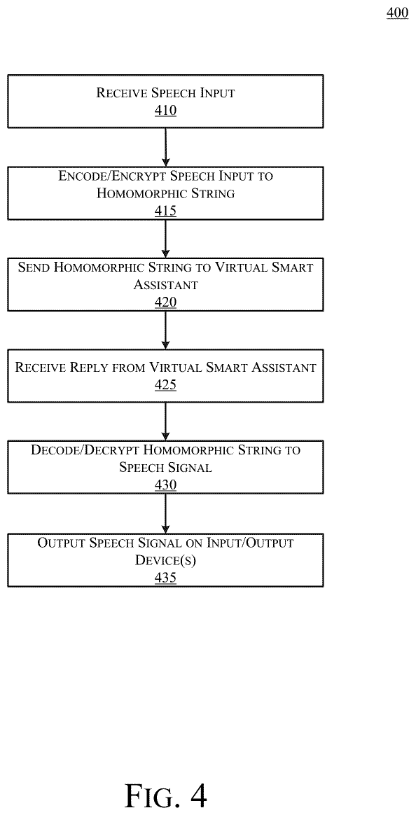

FIG. 4 is a flowchart illustrating operations in a method to implement a privacy preserving digital personal assistant in accordance with some examples. Referring to FIG. 4, in operation, a user of the trusted compute environment 100 may initiate a query to a digital personal assistant, e.g., by asking a question to the digital personal assistant. At operation 210 the speech from a user is received and is input to the encoder/encryptor circuit 116 which, at operation 415 encodes and/or encrypts the speech input to an encrypted homomorphic ciphertext using a private encryption key 122 associated with the trusted compute environment 110. At operation 225 the homomorphic string is sent to the homomorphic encryption-based speech-to-text converter 144, which converts the homomorphically encrypted speech signal to a homomorphically encrypted string (i.e., a ciphertext). The homomorphically encrypted string is passed to a natural language processing module 144 adapted to analyze homomorphically encrypted strings to obtain a matching result to the input homomorphically encrypted string. This matching result is sent to the trusted compute environment 110 as a reply, also in the form of a homomorphically encrypted string (i.e., ciphertext), which can only be decrypted with the private key 122.

At operation 425 the reply from the natural language processing module 144 is received in the trusted compute environment 100. At operation 430 the reply is input to the decoder/decryptor circuit 126, which decrypts the response using the private key 122 to generate a speech signal. The speech signal is input to one or more input/output devices (e.g., a speaker) which, at operation 435, outputs the speech signal.

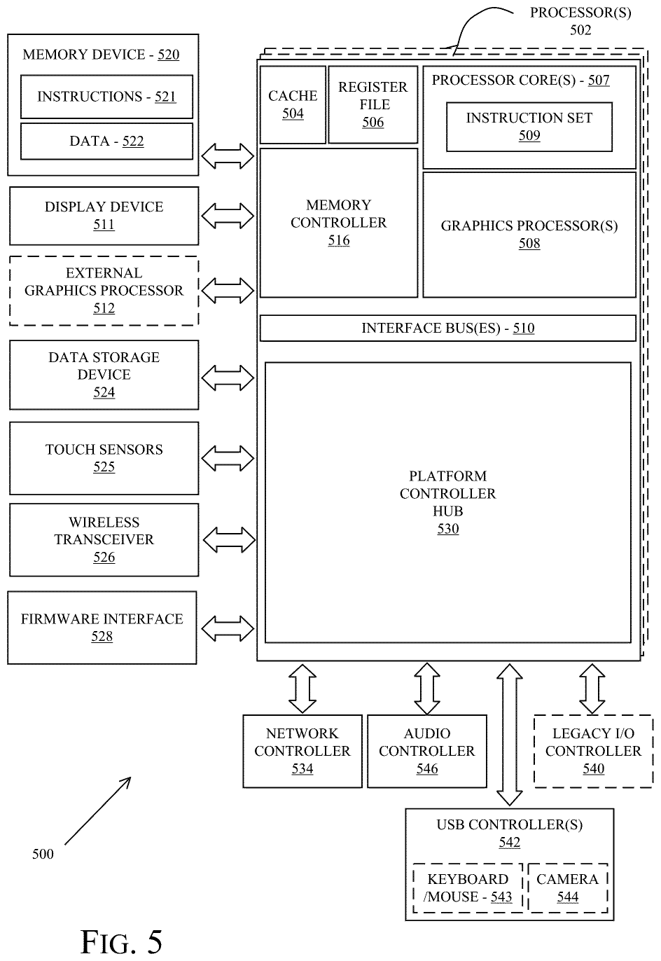

FIG. 5 illustrates an embodiment of an exemplary computing architecture that may be suitable for implementing various embodiments as previously described. In various embodiments, the computing architecture 500 may comprise or be implemented as part of an electronic device. In some embodiments, the computing architecture 500 may be representative, for example of a computer system that implements one or more components of the operating environments described above. In some embodiments, computing architecture 500 may be representative of one or more portions or components of a digital signature signing system that implement one or more techniques described herein. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 500.

As shown in FIG. 5, the computing architecture 500 includes one or more processors 502 and one or more graphics processors 508, and may be a single processor desktop system, a multiprocessor workstation system, or a server system having a large number of processors 502 or processor cores 507. In on embodiment, the system 500 is a processing platform incorporated within a system-on-a-chip (SoC or SOC) integrated circuit for use in mobile, handheld, or embedded devices.

An embodiment of system 500 can include, or be incorporated within, a server-based gaming platform, a game console, including a game and media console, a mobile gaming console, a handheld game console, or an online game console. In some embodiments system 500 is a mobile phone, smart phone, tablet computing device or mobile Internet device. Data processing system 500 can also include, couple with, or be integrated within a wearable device, such as a smart watch wearable device, smart eyewear device, augmented reality device, or virtual reality device. In some embodiments, data processing system 500 is a television or set top box device having one or more processors 502 and a graphical interface generated by one or more graphics processors 508.

In some embodiments, the one or more processors 502 each include one or more processor cores 507 to process instructions which, when executed, perform operations for system and user software. In some embodiments, each of the one or more processor cores 507 is configured to process a specific instruction set 509. In some embodiments, instruction set 509 may facilitate Complex Instruction Set Computing (CISC), Reduced Instruction Set Computing (RISC), or computing via a Very Long Instruction Word (VLIW). Multiple processor cores 507 may each process a different instruction set 509, which may include instructions to facilitate the emulation of other instruction sets. Processor core 507 may also include other processing devices, such a Digital Signal Processor (DSP).

In some embodiments, the processor 502 includes cache memory 504. Depending on the architecture, the processor 502 can have a single internal cache or multiple levels of internal cache. In some embodiments, the cache memory is shared among various components of the processor 502. In some embodiments, the processor 502 also uses an external cache (e.g., a Level-3 (L3) cache or Last Level Cache (LLC)) (not shown), which may be shared among processor cores 507 using known cache coherency techniques. A register file 506 is additionally included in processor 502 which may include different types of registers for storing different types of data (e.g., integer registers, floating point registers, status registers, and an instruction pointer register). Some registers may be general-purpose registers, while other registers may be specific to the design of the processor 502.

In some embodiments, one or more processor(s) 502 are coupled with one or more interface bus(es) 510 to transmit communication signals such as address, data, or control signals between processor 502 and other components in the system. The interface bus 510, in one embodiment, can be a processor bus, such as a version of the Direct Media Interface (DMI) bus. However, processor busses are not limited to the DMI bus, and may include one or more Peripheral Component Interconnect buses (e.g., PCI, PCI Express), memory busses, or other types of interface busses. In one embodiment the processor(s) 502 include an integrated memory controller 516 and a platform controller hub 530. The memory controller 516 facilitates communication between a memory device and other components of the system 500, while the platform controller hub (PCH) 530 provides connections to I/O devices via a local I/O bus.

Memory device 520 can be a dynamic random-access memory (DRAM) device, a static random-access memory (SRAM) device, flash memory device, phase-change memory device, or some other memory device having suitable performance to serve as process memory. In one embodiment the memory device 520 can operate as system memory for the system 500, to store data 522 and instructions 521 for use when the one or more processors 502 executes an application or process. Memory controller hub 516 also couples with an optional external graphics processor 512, which may communicate with the one or more graphics processors 508 in processors 502 to perform graphics and media operations. In some embodiments a display device 511 can connect to the processor(s) 502. The display device 511 can be one or more of an internal display device, as in a mobile electronic device or a laptop device or an external display device attached via a display interface (e.g., DisplayPort, etc.). In one embodiment the display device 511 can be a head mounted display (HMD) such as a stereoscopic display device for use in virtual reality (VR) applications or augmented reality (AR) applications.

In some embodiments the platform controller hub 530 enables peripherals to connect to memory device 520 and processor 502 via a high-speed I/O bus. The I/O peripherals include, but are not limited to, an audio controller 546, a network controller 534, a firmware interface 528, a wireless transceiver 526, touch sensors 525, a data storage device 524 (e.g., hard disk drive, flash memory, etc.). The data storage device 524 can connect via a storage interface (e.g., SATA) or via a peripheral bus, such as a Peripheral Component Interconnect bus (e.g., PCI, PCI Express). The touch sensors 525 can include touch screen sensors, pressure sensors, or fingerprint sensors. The wireless transceiver 526 can be a Wi-Fi transceiver, a Bluetooth transceiver, or a mobile network transceiver such as a 3G, 4G, or Long Term Evolution (LTE) transceiver. The firmware interface 528 enables communication with system firmware, and can be, for example, a unified extensible firmware interface (UEFI). The network controller 534 can enable a network connection to a wired network. In some embodiments, a high-performance network controller (not shown) couples with the interface bus 510. The audio controller 546, in one embodiment, is a multi-channel high definition audio controller. In one embodiment the system 500 includes an optional legacy I/O controller 540 for coupling legacy (e.g., Personal System 2 (PS/2)) devices to the system. The platform controller hub 530 can also connect to one or more Universal Serial Bus (USB) controllers 542 connect input devices, such as keyboard and mouse 543 combinations, a camera 544, or other USB input devices.

The following pertains to further examples.

Example 1 is an apparatus, comprising processing circuitry to receive, from an input device, an input speech signal; encode the input speech signal to generate a first homomorphically encrypted string; send the homomorphically encrypted string to a remote device via communication link; receive, from the remote device, a reply comprising a second homomorphically encrypted string; decode the second homomorphically encrypted string into an output speech signal; and output the output speech signal on an audio output device.

In Example 2, the subject matter of Example 1 can optionally include processing circuitry to encrypt the input speech signal using a private encryption key to generate the first homomorphically encrypted string.

In Example 3, the subject matter of any one of Examples 1-2 can optionally include processing circuitry to decrypt the second homomorphically encrypted string using the private encryption key.

In Example 4, the subject matter of any one of Examples 1-3 can optionally include processing circuitry to convert the input speech signal to a first cleartext string; and encrypt the cleartext string using a public encryption key to generate the first homomorphically encrypted string.

In Example 5, the subject matter of any one of Examples 1-4 can optionally include processing circuitry to decrypt the second homomorphically encrypted string using a private encryption key to generate a second cleartext string; and convert the second cleartext string to the output speech signal.

In Example 6, the subject matter of any one of Examples 1-5 can optionally include an arrangement wherein the communication link is an unsecure communication link.

In Example 7, the subject matter of any one of Examples 1-6 can optionally include an arrangement wherein the remote device comprises a homomorphic digital assistant service engine.

Example 8 is a computer-based method, comprising receiving, from an input device, an input speech signal; encoding the input speech signal to generate a first homomorphically encrypted string; sending the homomorphically encrypted string to a remote device via communication link; receiving, from the remote device, a reply comprising a second homomorphically encrypted string; decoding the second homomorphically encrypted string into an output speech signal; and outputting the output speech signal on an audio output device.

In Example 9, the subject matter of Example 8 further comprising encrypting the input speech signal using a private encryption key to generate the first homomorphically encrypted string.

In Example 10, the subject matter of any one of Examples 8-9 can optionally include decrypting the second homomorphically encrypted string using the private encryption key.

In Example 11, the subject matter of any one of Examples 8-10 can optionally include converting the input speech signal to a first cleartext string; and encrypting the cleartext string using a public encryption key to generate the first homomorphically encrypted string.

In Example 12, the subject matter of any one of Examples 8-11 can optionally include decrypting the second homomorphically encrypted string using a private encryption key to generate a second cleartext string; and converting the second cleartext string to the output speech signal.

In Example 13, the subject matter of any one of Examples 8-12 can optionally include an arrangement wherein the communication link is an unsecure communication link.

In Example 14, the subject matter of any one of Examples 8-13 can optionally include an arrangement wherein the remote device comprises a homomorphic digital assistant service engine.

Example 15 is a non-transitory computer readable medium comprising instructions which, when executed by a processor, configure the processor to receive, from an input device, an input speech signal; encode the input speech signal to generate a first homomorphically encrypted string; send the homomorphically encrypted string to a remote device via communication link; receive, from the remote device, a reply comprising a second homomorphically encrypted string; decode the second homomorphically encrypted string into an output speech signal; and output the output speech signal on an audio output device.

In Example 16, the subject matter of Example 15 can optionally include the subject matter of claim 15, comprising instructions to encrypt the input speech signal using a private encryption key to generate the first homomorphically encrypted string.

In Example 17, the subject matter of any one of Examples 15-16 can optionally include instructions to decrypt the second homomorphically encrypted string using the private encryption key.

In Example 18, the subject matter of any one of Examples 15-17 can optionally include instructions to convert the input speech signal to a first cleartext string; and encrypt the cleartext string using a public encryption key to generate the first homomorphically encrypted string.

In Example 19, the subject matter of any one of Examples 15-18 can optionally include instructions to decrypt the second homomorphically encrypted string using a private encryption key to generate a second cleartext string; and convert the second cleartext string to the output speech signal.

In Example 20, the subject matter of any one of Examples 15-19 can optionally include an arrangement wherein the communication link is an unsecure communication link.

In Example 21, the subject matter of any one of Examples 15-20 can optionally include an arrangement wherein the remote device comprises a homomorphic digital assistant service engine.

The above Detailed Description includes references to the accompanying drawings, which form a part of the Detailed Description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In addition “a set of” includes one or more elements. In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim are still deemed to fall within the scope of that claim. Moreover, in the following claims, the terms “first,” “second,” “third,” etc. are used merely as labels, and are not intended to suggest a numerical order for their objects.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with each claim standing on its own as a separate embodiment. The scope of the embodiments disclosed herein is to be determined with reference to the appended claims, along with the full scope of equivalents to which such claims are entitled.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus, comprising:
processing circuitry to:
receive, from an input device, an input speech signal;
encode the input speech signal to generate a first homomorphically encrypted string;
send the homomorphically encrypted string to a remote device via communication link;
receive, from the remote device, a reply comprising a second homomorphically encrypted string;
decode the second homomorphically encrypted string into an output speech signal; and
output the output speech signal on an audio output device.

2. The apparatus of claim 1, the processing circuitry to:
encrypt the input speech signal using a private encryption key to generate the first homomorphically encrypted string.

3. The apparatus of claim 2, the processing circuitry to:
decrypt the second homomorphically encrypted string using the private encryption key.

4. The apparatus of claim 1, the processing circuitry to:
convert the input speech signal to a first cleartext string; and
encrypt the cleartext string using a public encryption key to generate the first homomorphically encrypted string.

5. The apparatus of claim 1, the processing circuitry to:
decrypt the second homomorphically encrypted string using a private encryption key to generate a second cleartext string; and
convert the second cleartext string to the output speech signal.

6. The apparatus of claim 1, wherein the communication link is an unsecure communication link.

7. The apparatus of claim 1, wherein the remote device comprises a homomorphic digital assistant service engine.

8. A computer-based method, comprising:
receiving, from an input device, an input speech signal;
encoding the input speech signal to generate a first homomorphically encrypted string;
sending the homomorphically encrypted string to a remote device via communication link;
receiving, from the remote device, a reply comprising a second homomorphically encrypted string;
decoding the second homomorphically encrypted string into an output speech signal; and
outputting the output speech signal on an audio output device.

9. The method of claim 8, further comprising:
encrypting the input speech signal using a private encryption key to generate the first homomorphically encrypted string.

10. The method of claim 9, further comprising:
decrypting the second homomorphically encrypted string using the private encryption key.

11. The method of claim 8, further comprising:
converting the input speech signal to a first cleartext string; and
encrypting the cleartext string using a public encryption key to generate the first homomorphically encrypted string.

12. The method of claim 8, further comprising:
decrypting the second homomorphically encrypted string using a private encryption key to generate a second cleartext string; and
converting the second cleartext string to the output speech signal.

13. The method of claim 8, wherein the communication link is an unsecure communication link.

14. The method of claim 12, wherein the remote device comprises a homomorphic digital assistant service engine.

15. A non-transitory computer readable medium comprising instructions which, when executed by a processor, configure the processor to:
receive, from an input device, an input speech signal;
encode the input speech signal to generate a first homomorphically encrypted string;
send the homomorphically encrypted string to a remote device via communication link;
receive, from the remote device, a reply comprising a second homomorphically encrypted string;
decode the second homomorphically encrypted string into an output speech signal; and
output the output speech signal on an audio output device.

16. The computer readable medium of claim 15, comprising instructions to:
encrypt the input speech signal using a private encryption key to generate the first homomorphically encrypted string.

17. The computer readable medium of claim 16, comprising instructions to:
decrypt the second homomorphically encrypted string using the private encryption key.

18. The computer readable medium of claim 15, comprising instructions to:
convert the input speech signal to a first cleartext string; and
encrypt the cleartext string using a public encryption key to generate the first homomorphically encrypted string.

19. The computer readable medium of claim 15, comprising instructions to:
decrypt the second homomorphically encrypted string using a private encryption key to generate a second cleartext string; and
convert the second cleartext string to the output speech signal.

20. The computer readable medium of claim 15, wherein the communication link is an unsecure communication link.

21. The computer readable medium of claim 20, wherein the remote device comprises a homomorphic digital assistant service engine.
